(19) United States
(12) Patent Application Publication
(10) Pub. No.: US 2010/0119178 A1
(43) Pub. Date: May 13, 2010

(54) Disposable Cleaning Bag

(76) Inventor: Sung-Po Tsai, Sihu Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/270,057

(22) Filed: Nov. 13, 2008

(51) Int. Cl. B65D 33/08; A01K 29/00

(52) U.S. Cl. 383/7; 294/1.3

(57) ABSTRACT

A disposable cleaning bag includes a first bag body provided with at least one first through hole, a second bag body laminating with the first bag body and provided with at least one second through hole, and an opening formed between the first bag body and the second bag body. Thus, the cleaning bag separate the user's hand from the waste matters to prevent the user's hand from directly touching the waste matters. In addition, the first through hole of the first bag body and the second through hole of the second bag body function as a holding portion to allow insertion of the user's fingers so as to facilitate the user carrying the cleaning bag.

### BACKGROUND OF THE INVENTION

1. Field of the Invention

The present invention relates to a cleaning bag and, more particularly, to a disposable cleaning bag to clean the waste matters of a pet.

2. Description of the Related Art

When a person takes his/her pet outdoors, he/she has to prepare a carrying tool, such as useless newspapers, tissue papers and the like, so as to clean and carry the waste matters of the pet. However, when the user uses the useless newspapers or tissue papers to take the waste matters of the pet, the user's hand easily touches the waste matters unintentionally, thereby greatly causing an uncomfortable sensation to the user, and thereby easily incurring a sanitary problem. In addition, the user cannot take or carry the waste matters in the useless newspapers or tissue papers easily and conveniently, so that he/she has to search for a rubbish bin to throw away the waste matters, thereby greatly causing inconvenience to the user.

### BRIEF SUMMARY OF THE INVENTION

In accordance with the present invention, there is provided a disposable cleaning bag, comprising a first bag body provided with at least one first through hole, a second bag body laminating with the first bag body and provided with at least one second through hole, and an opening formed between the first bag body and the second bag body.

The primary objective of the present invention is to provide a disposable cleaning bag, wherein the first bag body and the second bag body separate the user's hand from the waste matters to prevent the user's hand from directly touching the waste matters so as to provide a comfortable sensation to the user and to prevent from incurring a sanitary problem.

Another objective of the present invention is to provide a disposable cleaning bag, wherein the first through hole of the first bag body and the second through hole of the second bag body function as a holding portion to allow insertion of the user's fingers so as to facilitate the user carrying the cleaning bag.

A further objective of the present invention is to provide a disposable cleaning bag, wherein the cleaning bag is made of a plastic thin film which is gas impermeable and air-tight to prevent the odor, wet and dirt of the waste matters from leaking from the cleaning bag.

A further objective of the present invention is to provide a disposable cleaning bag, wherein the first bag body has an end face provided with an elongated holding ear which extends through and protrudes outwardly from the second through hole of the second bag body to facilitate the user carrying the cleaning bag.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a disposable cleaning bag in accordance with the preferred embodiment of the present invention.

FIG. 2 is a schematic operational view of the disposable cleaning bag as shown in FIG. 1.

FIG. 3 is a schematic operational view of the disposable cleaning bag as shown in FIG. 2.

FIG. 4 is a schematic operational view of the disposable cleaning bag as shown in FIG. 3.

FIG. 5 is a perspective view of a disposable cleaning bag in accordance with another preferred embodiment of the present invention.

### DETAILED DESCRIPTION OF THE INVENTION

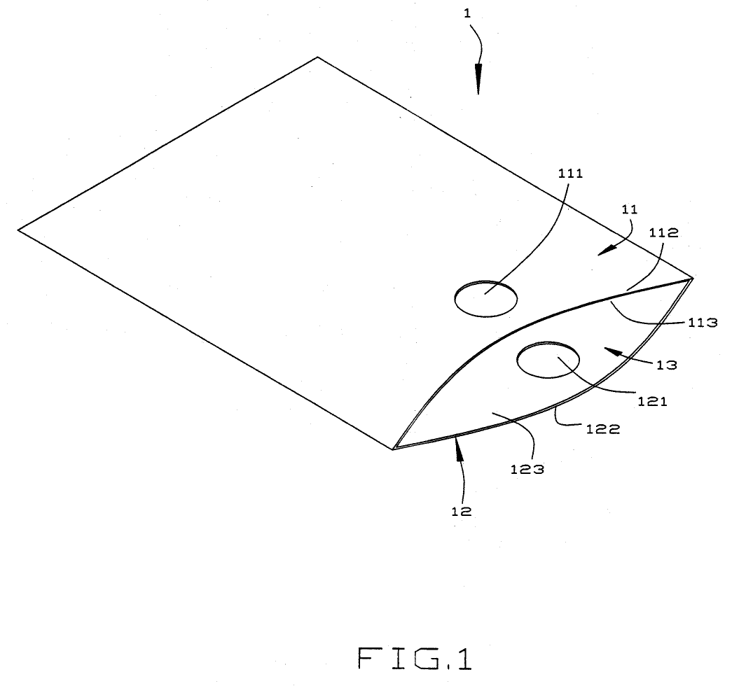

Referring to the drawings and initially to FIG. 1, a disposable cleaning bag 1 in accordance with the preferred embodiment of the present invention comprises a first bag body 11 provided with at least one first through hole 111, a second bag body 12 laminating with the first bag body 11 and provided with at least one second through hole 121, and an opening 13 formed between the first bag body 11 and the second bag body 12.

The opening 13 is located at two juxtaposed end portions of the first bag body 11 and the second bag body 12.

The first bag body 11 is made of flexible material, such as a plastic thin film. The first bag body 11 has an inner layer 113 and an outer layer 112. The first through hole 111 of the first bag body 11 is located beside and connected to the opening 13. The first through hole 111 of the first bag body 11 has a circular shape. The first through hole 111 of the first bag body 11 extends through a whole thickness of the first bag body 11.

The second bag body 12 is made of flexible material, such as a plastic thin film. The second bag body 12 has an inner layer 123 and an outer layer 122. The second through hole 121 of the second bag body 12 is located beside and connected to the opening 13. The second through hole 121 of the second bag body 12 has a circular shape. The second through hole 121 of the second bag body 12 extends through a whole thickness of the second bag body 12. The second through hole 121 of the second bag body 12 aligns with the first through hole 111 of the first bag body 11.

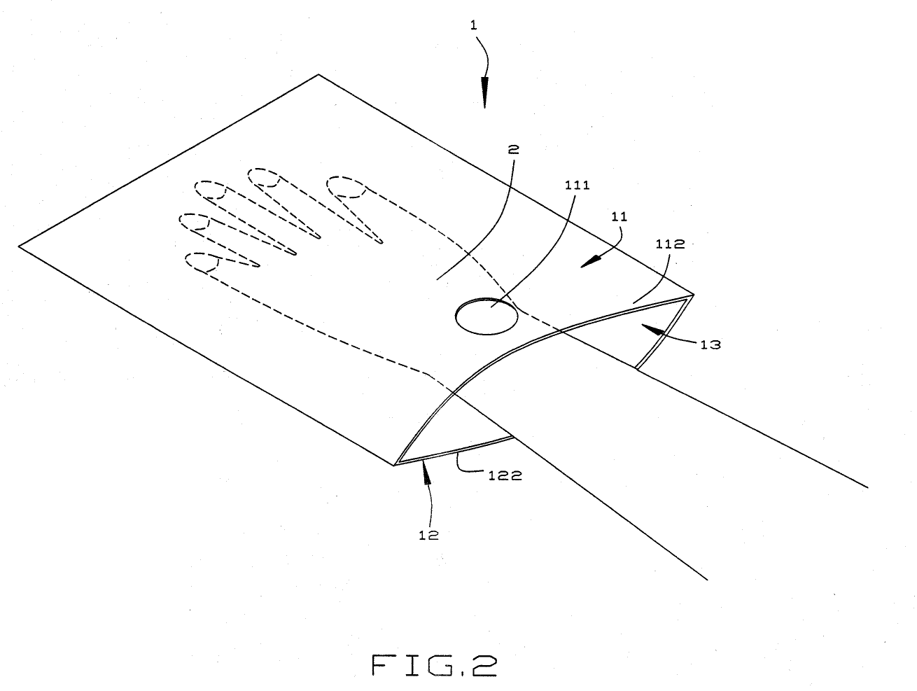

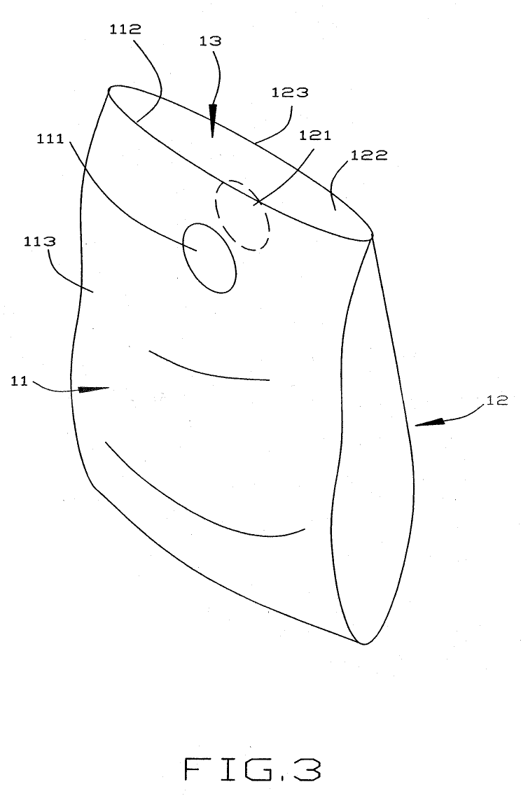

When in use, referring to FIGS. 2 and 3 with reference to FIG. 1, a user's one hand is inserted through the opening 13 into the space between the first bag body 11 and the second bag body 12 as shown in FIG. 2 to hold waste matters of his/her pet, so that the waste matters are placed on the outer layer 112 of the first bag body 11 or the outer layer 122 of the second bag body 12. At this time, the first bag body 11 and the second bag body 12 separate the user's hand from the waste matters to prevent the user's hand from directly touching the waste matters. Then, the first bag body 11 and the second bag body 12 are turned inside out from the opening 13 so that the inner layer 113 of the first bag body 11 and the inner layer 123 of the second bag body 12 are exposed outwardly, while the outer layer 112 of the first bag body 11 and the outer layer 122 of the second bag body 12 are hidden inwardly as shown in FIG. 3 to encompass the waste matters between the outer layer 112 of the first bag body 11 and the outer layer 122 of the second bag body 12 so as to place the waste matters in the cleaning bag 1 completely. At this time, the first through hole 111 of the first bag body 11 and the second through hole 121 of the second bag body 12 function as a holding portion to allow insertion of the user's fingers so as to facilitate the user carrying the cleaning bag 1. In such a manner, the cleaning bag 1 is made of a plastic thin film which is gas impermeable and air-tight to prevent the odor, wet and dirt of the waste matters from leaking from the cleaning bag 1.

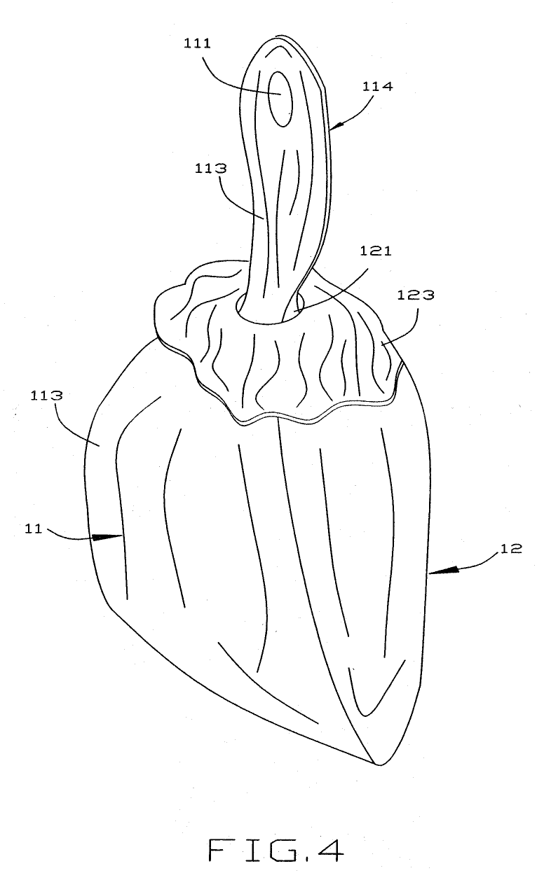

Referring to FIG. 4 with reference to FIGS. 1-3, the first bag body 11 has an end face provided with an elongated holding ear 114 which extends through and protrudes outwardly from the second through hole 121 of the second bag body 12 to facilitate the user carrying the cleaning bag 1. The first through hole 111 of the first bag body 11 is formed in the elongated holding ear 114.

Referring to FIG. 1, the cleaning bag 1 has a rectangular shape.

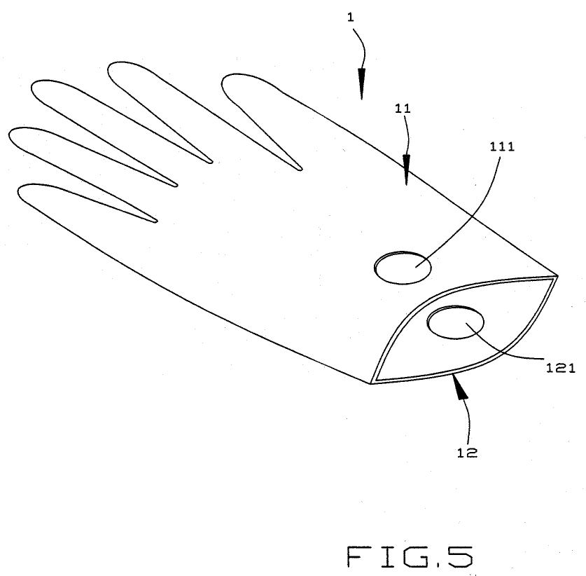

Referring to FIG. 5, the cleaning bag 1 has the shape of a human hand according to the user's requirement.

Accordingly, the first bag body 11 and the second bag body 12 separate the user's hand from the waste matters to prevent the user's hand from directly touching the waste matters so as to provide a comfortable sensation to the user and to prevent from incurring a sanitary problem. In addition, the first through hole 111 of the first bag body 11 and the second through hole 121 of the second bag body 12 function as a holding portion to allow insertion of the user's fingers so as to facilitate the user carrying the cleaning bag 1. Further, the cleaning bag 1 is made of a plastic thin film which is gas impermeable and air-tight to prevent the odor, wet and dirt of the waste matters from leaking from the cleaning bag 1. Further, the first bag body 11 has an end face provided with an elongated holding ear 114 which extends through and protrudes outwardly from the second through hole 121 of the second bag body 12 to facilitate the user carrying the cleaning bag 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A disposable cleaning bag, comprising:
a first bag body provided with at least one first through hole;
a second bag body laminating with the first bag body and provided with at least one second through hole;
an opening formed between the first bag body and the second bag body.

2. The disposable cleaning bag of claim 1, wherein
the first bag body is made of flexible material;
the second bag body is made of flexible material.

3. The disposable cleaning bag of claim 1, wherein
the first bag body is made of a plastic thin film;
the second bag body is made of a plastic thin film.

4. The disposable cleaning bag of claim 1, wherein
the first through hole of the first bag body has a circular shape;
the second through hole of the second bag body has a circular shape.

5. The disposable cleaning bag of claim 1, wherein
the first through hole of the first bag body is located beside the opening;
the second through hole of the second bag body is located beside the opening.

6. The disposable cleaning bag of claim 1, wherein
the first through hole of the first bag body is connected to the opening;
the second through hole of the second bag body is connected to the opening.

7. The disposable cleaning bag of claim 1, wherein the opening is located at two juxtaposed end portions of the first bag body and the second bag body.

8. The disposable cleaning bag of claim 1, wherein the first through hole of the first bag body extends through a whole thickness of the first bag body.

9. The disposable cleaning bag of claim 1, wherein the second through hole of the second bag body extends through a whole thickness of the second bag body.

10. The disposable cleaning bag of claim 1, wherein the second through hole of the second bag body aligns with the first through hole of the first bag body.

11. The disposable cleaning bag of claim 1, wherein the first through hole of the first bag body and the second through hole of the second bag body function as a holding portion to allow insertion of a user's fingers so as to facilitate the user carrying the cleaning bag.

12. The disposable cleaning bag of claim 1, wherein the first bag body has an end face provided with an elongated holding ear.

13. The disposable cleaning bag of claim 12, wherein the elongated holding ear of the first bag body extends through and protrudes outwardly from the second through hole of the second bag body.

14. The disposable cleaning bag of claim 12, wherein the first through hole of the first bag body is formed in the elongated holding ear.
